(19) United States
(12) Patent Application Publication
(10) Pub. No.: US 2008/0307693 A1
(43) Pub. Date: Dec. 18, 2008

(54) Floating fish container

(76) Inventor: Anne Wessels, Columbus, TX (US)

Correspondence Address: LAW OFFICE OF DAVID MCEWING, P.O. BOX 231324, HOUSTON, TX, 77023, US

(21) Appl. No.: 11/820,157

(22) Filed: Jun. 18, 2007

(51) Int. Cl. A01K 97/20; A01K 97/05

(52) U.S. Cl. 43/55

(57) ABSTRACT

A floating fish holding container that rides in the water partially submerged with perforated sides and a top including a flexible net material spanning the container top with a closeable opening to the net. The floating live fish container is made of sufficiently strong plastic material to withstand shark attacks directed at the catch inside the container. The device also has perforated side walls to permit the flow of water into the container.

### BACKGROUND TO DEVICE

1. Field of Device

The device subject of this disclosure pertains to a shark or predetor resistant storage container for holding live fish, particularly holding fish immediately after being caught.

2. Related Technology

There are numerous devices for the holding of live fish.

### SUMMARY OF DEVICE

The device comprises a partially submerged container with perforated sides and having a top including a flexible net material spanning the top with a closeable opening to the net. The device also includes flotation components mounted to the top structure and container side walls containing perforations for the passage of water between the inside of the container and the outside; and a bottom.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the exterior of the container, including the float mechanism at the top and the perforated container sides.

FIG. 2 illustrates the flexible netting covering the top of the container.

### DETAILED DESCRIPTION OF THE DEVICE

Fishing is a very old occupation and popular sport. Fishing is conducted in multiple and diverse environments. There of course is ice fishing. There is ocean fishing conducted miles offshore in ocean worthy vessels. There is fishing in streams and ponds, including fly fishing. People fish from boats or from the banks of rivers, streams and lakes. In some instances, the fishermen stand in the water, frequently wearing waders, i.e., water proof leggings that can is some instances extend to the wearer's chest.

With each type of fishing there is equipment that has been designed to assist the fisherman in the particular environment. Examples of this equipment include rods and reels, line, hooks, nets, holding containers.

As indicated, the equipment is as diverse as the environment or fishing activity. Fishing for catfish in a large river requires different equipment from trout fishing in a mountain stream.

The device subject of the instant invention applies to fishing performed in coastal tidewater or bays. The fisherman wades into the water with his/her rod and reel. The fisherman is also equipped with a live fish container. The container top floats on the surface of the water and the lower portion remains submerged in the water. Caught fish can be placed in the container. The fish cannot escape from the container top due to a net that spans across the top of the container. The netting includes an opening. In one embodiment, the net can be closed by pulling on a draw string. The top surface enclosure may be at the water surface level or above the water level. The opening of the netting is designed to be controllable by the fisherman with one hand (holding a squirming fish). The drawstring opening also allows easy expansion in order that the fish can be placed in the container.

The fish holding container can be tied or otherwise attached to the fisherman, for example at a cord and spring clip attached to a loop fixed the fisherman's waders. This allows the container to follow behind the fisherman while casting the fishing line. Other forms of attachment component may be used. Since the container floats, it does not sink down beneath the water to be snagged on submerged logs or other objects of the tidal area. This preserves the freedom of movement of the fisherman walking through the water.

One of the challenges of the fishing described in the tidal area is the presence of sharks or other predators in the water. Particularly, the predators attack the caught fish stored in the fisherman's fish container. Heretofore, netting has been used in conjunction with floats as containment devices for caught fish. Unfortunately, the netting has been too easily bitten through or bent by sharks, allowing the fish to either escape or be eaten by the sharks. In any event the catch is lost to the fisherman. Metal cages have been utilized. However there has been difficulty in maintaining buoyancy due to the weight of the metal. Also it is desirable that the overall weight remain as light as possible.

As indicated by the limitations of past equipment, the selection of material and the material properties are important. The present device may comprise various types of plastics such as polycarbonates. For example, polycarbonates have been used as animal cages. Other suitable materials include but are not limited to PVC, polystyrene and nylon. The thickness of device in one embodiment is approximately 3/32 of an inch. Heavier gauge material may also be desirable such as ⅛ inch.

These materials may be used to form the holding basket. This portion of the device is impenetrable or deterrent to sharks. The material is sufficiently resilient to withstand the crushing shark bite.

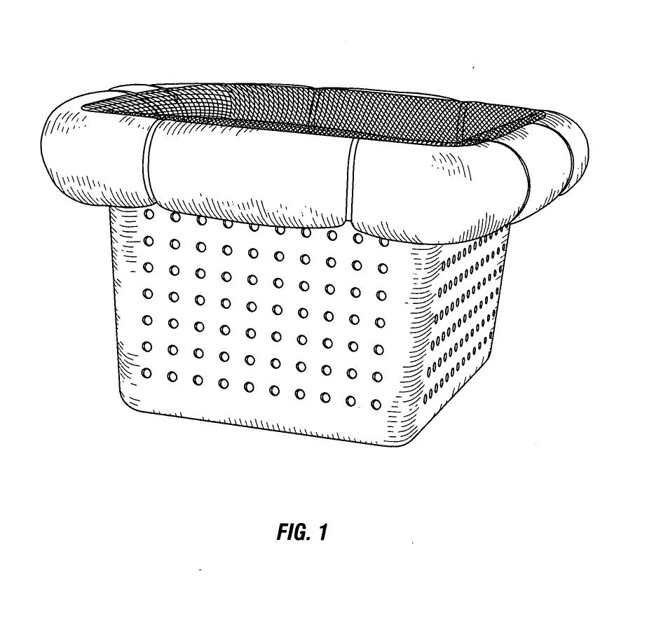

FIG. 1 illustrates the perforated sides of the container. Illustrated are each of the four sides perforated. The perforations are approximately ¼ inch diameter and are spaced approximately each 1 and ¼ inches. However, not all the sides are required to be perforated. Alternatively, container bottom may be perforated. As indicated, the purpose of the perforations is to allow the circulation of water in the container to enable the captured fish to stay alive.

FIG. 1 further illustrates a foam floatation device attached to the top rim of the container. This floatation device can be made, for example from closed cell polystyrene. The purpose of the flotation device is to hold the device proximate to the surface level of the water. This is also a function of the center of gravity of the device. In the embodiment illustrated, the flotation device is attached to the rim of the container utilizing plastic ties. Other attachment mechanisms such as clips, molded components that fit over the container edge, and glue.

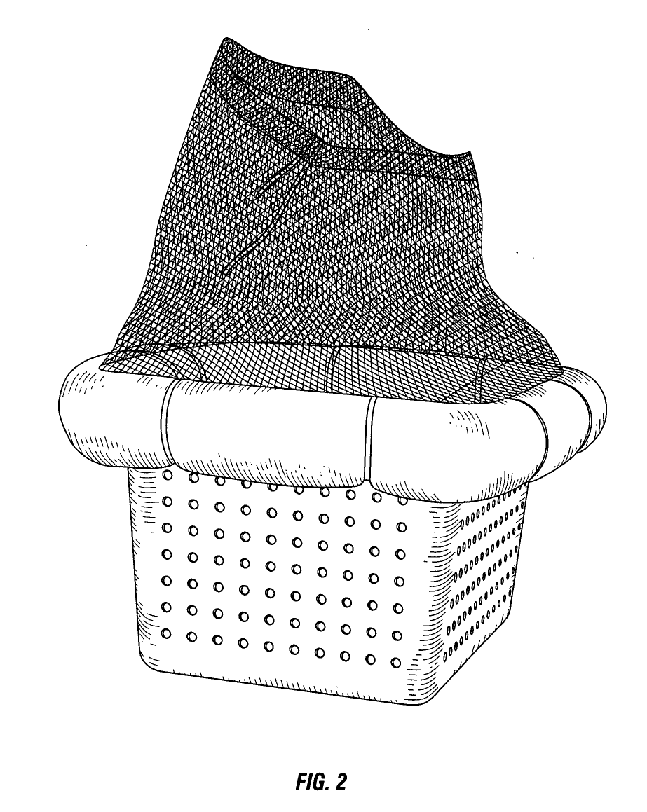

FIG. 2 illustrates the container, the floatation component and the flexible top net. The top net can have a center opening through which the catch can be inserted into the container. In the embodiment illustrated, the netting is woven nylon although other materials can be used.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A shark resistant tidewater fish storage container with perforated sides comprising:
a) a container having four sides and a bottom wherein the container is made between 3/32 and ⅛ inch thick polycarbonate, polystyrene, polyvinyl or nylon;
a) a container top including a flexible net material spanning the top with a closeable center opening with draw strings with access to the container;
b) flotation components mounted to a top structure of the container;
c) at least one container side wall containing perforations for the passage of water between the inside of the container and the outside sufficient to keep fish alive within the container.

2. The device of claim 1 further comprising a flotation component of closed cell foam.

3. The device of claim 1 further comprising container having perforations in all four sides and the bottom of the container.

4. The device of claim 1 further comprising an attachment component between the fisherman and the container.

5. The device of claim 1 further comprising top netting comprising nylon.

6. The device of claim 1 further comprising a center of gravity such that the top of the container remains proximate to the water surface level.

7. (canceled)

8. A live fish holding container wherein the container has four sides is place in the water and the top of the container floats at the water surface comprising:
a) an open container top enclosed with a flexible net wherein the net has a middle opening;
b) a container having a bottom and four sides and made from resilient plastic sufficient to withstand a shark bite;
c) perforations for the passage of water on each of the four sides;
d) a foam flotation device attached to the top of each side of the container.
